(19) United States
(12) Patent Application Publication
(10) Pub. No.: US 2004/0122596 A1
(43) Pub. Date: Jun. 24, 2004

(54) Method for high frequency restoration of seismic data

(75) Inventors: Vasudhaven Sudhakar, Alberta (CA); Satinder Chopra, Alberta (CA)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Core Laboratories, Inc.

(21) Appl. No.: 10/324,164

(22) Filed: Dec. 19, 2002

(51) Int. Cl. G01V 1/28

(52) U.S. Cl. 702/17

(57) ABSTRACT

The method of the present invention provides for processing seismic data over a subsurface area of interest. Downgoing seismic data, which may be VSP data, and surface seismic data are acquired over a subsurface area of interest. An inverse operator is determined from changes in signal characteristics, which may be first-arrival signals, between consecutive depth levels of the downgoing VSP data. The inverse operator is assigned to at least one surface seismic data level. Data levels may be in time or depth. Inverse operators may be interpolated for time or depth level operators for data samples between already determined operators. Inverse operators are applied to seismic data to restore attenuated signal components.

### FIELD OF THE INVENTION

This invention relates to the field of geophysical prospecting and, more particularly, to a method to obtain enhanced seismographs of the earth's subsurface formations.

### BACKGROUND OF THE INVENTION

In the oil and gas industry, geophysical prospecting techniques are commonly used to aid in the search for and evaluation of subterranean hydrocarbon deposits. Generally, a seismic energy source is used to generate a seismic signal which propagates into the earth and is at least partially reflected by subsurface seismic reflectors (i.e., interfaces between underground formations having different acoustic impedances). The reflections are recorded by seismic detectors located at or near the surface of the earth, in a body of water, or at known depths in boreholes, and the resulting seismic data may be processed to yield information relating to the location of the subsurface reflectors and the physical properties of the subsurface formations.

It is a common observation that seismic waves propagating through the earth are attenuated. As these elastic waves travel deeper they lose energy, in contrast to spherical spreading—where energy is spread over a wider area and reflection and transmission of energy at interfaces—where its redistribution occurs in the upward or downward directions. This loss is frequency dependent—higher frequencies are absorbed more rapidly than lower frequencies, such that the highest frequency usually recovered on most seismic data is about 80 Hz. Moreover, absorption appears to vary with lithology of the medium. The unconsolidated near surface absorbs more energy than the underlying compact rocks. In the extreme case, most of the energy may be absorbed in the first few hundred metres of the subsurface. It is therefore, important to study absorption and determine ways in which it can manifest itself on seismic data. It would be desirable to able to determined and apply a filter to compensate and/or restore seismic signals that have been attenuated and otherwise had signal characteristics altered.

### SUMMARY OF THE INVENTION

The method of the present invention provides for processing seismic data over a subsurface area of interest. Downgoing seismic data, which may be VSP data, and surface seismic data are acquired over a subsurface area of interest. An inverse operator is determined from changes in signal characteristics, which may be first-arrival signals, between consecutive depth levels of the downgoing VSP data. The inverse operator is assigned to at least one surface seismic data level. Data levels may be in time or depth. Inverse operators may be interpolated for time or depth level operators for data samples between already determined operators. Inverse operators are applied to seismic data to restore attenuated signal components.

### BRIEF DESCRIPTION OF THE DRAWINGS

The present invention and its advantages will be better understood by referring to the following detailed description and the attached drawings in which:

FIG. 1 illustrates a downgoing wavefield;

FIG. 2 illustrates Amplitude spectra at a different levels of the FIG. 1 wavefield;

FIG. 3 illustrates the correlation of well logs (in depth), a VSP upgoing wavefield, a corridor stack, well logs and seismic data;

FIG. 4 illustrates a set of interpolated operators;

FIG. 5 illustrates Q values determined from downgoing wavefield for intervals of a seismic section;

FIG. 6A illustrates seismic data;

FIG. 6B illustrates the Q compensated seismic data of Figure A;

FIG. 6C illustrates the seismic data of FIG. 6A compensated by the method of the present invention;

FIG. 7A illustrates seismic data showing a reef structure;

FIG. 7B illustrates the seismic data of FIG. 7A after processing with the method of the present invention;

FIG. 7C illustrates time slice seismic data;

FIG. 7D illustrates time slice seismic data after processing with the method of the present invention;

FIG. 8A illustrate segments of impedance sections;

FIG. 8B illustrate segments of impedance sections after application of the present invention;

FIG. 9A illustrates operators derived from Well A;

FIG. 9B illustrates operators derived from Well B;

FIG. 9C illustrates the difference of the derived operators;

FIG. 10 illustrates a flow chart of a method for forming the inverse operators; and

FIG. 11 illustrates a flow chart of a method for applying the inverse operators to seismic data.

While the invention will be described in connection with its preferred embodiments, it will be understood that the invention is not limited thereto. On the contrary, it is intended to cover all alternatives, modifications, and equivalents which may be included within the spirit and scope of the invention, as defined by the appended claims.

### DETAILED DESCRIPTION

The present invention is a method for compensating the attenuation properties of the earth and restoring much of the high frequency energy in spite of high frequencies that may be absorbed. Accordingly, this invention restores high frequencies that are still present in the data, although much of the high frequency energy may have been attenuated. Other advantages of the invention will be readily apparent to persons skilled in the art based on the following detailed description. To the extent that the following detailed description is specific to a particular embodiment or a particular use of the invention, this is intended to be illustrative and is not to be construed as limiting the scope of the invention.

The understanding of the attenuation properties of the earth has two major motivations. First, seismic wave amplitudes are reduced as waves propagate through the subsurface, and as stated above, this reduction is generally frequency dependent. Second, attenuation characteristics reveal much information, such as lithology and degree of saturation of rocks. The phenomenon of attenuation is much more complex than the elastic aspects of seismic wave propagation. Both laboratory and field measurements are difficult to make. There are numerous mechanisms contributing to attenuation and small changes in some conditions can affect attenuation significantly.

One commonly used measure of attenuation is the attenuation coefficient α, which is the exponential decay constant of the amplitude of a plane wave traveling in a homogeneous medium. The amplitude of a plane wave propagating in a homogeneous medium may be given as

Aᵣ=A₀exp(−αr) (1)

where Aᵣ is the amplitude at any distance r from the source.

A₀ is the initial or reference amplitude

α is the attenuation coefficient and is given as

$$α = \frac{π f}{QV} \qquad ( 2 )$$

where Q is called seismic quality factor and is the other commonly used measure of attenuation, V is the velocity, f is the frequency.

Laboratory and insitu measurements show that Q correlates with rock type, fluid type and degree of fluid saturation. Thus Q estimation is potentially diagnostic for reservoir characterization. Looking at the above equation one may draw the following conclusions:

Frequency: the higher the frequency content, the more it will get attenuated (direct proportionality). This seems logical as we may remember foghorns emit low-pitched sounds rather than high-pitched sounds, which would be absorbed in the fog.

Quality factor: the higher the value of Q, the less the attenuation the wave experiences (inverse proportionality)

Travel time: the longer the seismic wave travels, the more the attenuation (direct proportionality as in Table 1):

TABLE 1

| | | | Distance traveled until amplitude is |
|---|---|---|---|
| f | Q | V | reduced to 1/5 |
| 50 Hz | 50 | 2200 m/s | 1127 m |
| 30 Hz | 50 | 2200 m/s | 1878 m |
| 50 Hz | 150 | 2200 m/s | 5635 m |

As an example, let us find out how far does a wave of frequency 50 Hz travel in a medium with Q=150 and V=2200 m/s before it is reduced to one-fifth its amplitude. Using the above equation, x=1127 m. If the frequency of the wave were 30 Hz, the distance traveled may be found to be 1878 m, indicating higher frequency waves are attenuated faster as stated earlier. For the same frequency of incident wave, the distance traveled by it in a medium with Q=150, is r=5635 m which clarifies the fact the materials characterized by small values of Q are associated with significant decay of amplitudes. Most sedimentary rocks have a value of Q ranging from 20 to 200.

Seismic quality factor Q can provide significant information for hydrocarbon exploration. In addition to velocity and density, reliable estimates of Q could be a great help in improved understanding of lithology and physical state of subsurface rocks. Not only that, Q estimates could be used to determine the levels of fluid/gas saturation, because Q could be an order of magnitude more sensitive to changes in saturation or pore pressure than velocity. This has intrigued geophysicists for years to be able to come up with estimation of Q from subsurface data. Several investigators have demonstrated the computation of Q from seismic and Vertical Seismic Profile (VSP) data.

Let us consider the forward model for the seismic trace which may be written as

s(t)=w(t)*r(t)+n(t) (3)

where s(t) is the recorded seismic trace, w(t) is the basic seismic wavelet, r(t) is the earth's impulse response, n(t) is the random ambient noise, and * denotes convolution. One of the basic assumptions in this model is that the source waveform does not change as it travels in the subsurface—it is stationary. In actual practice we know that as a source waveform travels into the earth, its overall amplitude decays because of wavefront divergence. Also, frequencies are attenuated because of the absorption effects of rocks. At any given time, the wavelet is not the same as it was at the onset of source excitation. This earth filtering can be thought of as an exponential decay of energy with propagation distance. The net result is high frequency attenuation and dispersion. In other words, high frequencies traveling faster than low frequencies cause distortion of the source waveform. This time dependent change in waveform is called non-stationary. Non-stationary effects may also be due to intra-bed and inter-bed multiples.

Deconvolution tries to recover the reflectivity series from the recorded seismic trace. In equation 3 there are three unknowns—w(t), r(t) and n(t). The only known variable is the seismic trace—s(t).

In prior art practice, deconvolution is applied to the data by assuming that the mean value of the noise component n(t) is zero and the source waveform is known so that there is one unknown, r(t). If the source waveform w(t) is recorded during data acquisition, then the solution of the equation above is called deterministic. If the source waveform were unknown, then assuming that the autocorrelation of the source wavelet is the same as the autocorrelation of the seismic trace, the solution to the above equation can be found and is called statistical.

The usual approach to reduce non-stationarity is to apply processes designed to compensate for the effects of wavefront divergence and frequency attenuation. During processing of seismic data, wavefront divergence is removed by applying a spherical spreading function (same for all frequencies). Frequency attenuation is compensated for by different methods. The common practice has been to use multi-gate statistical deconvolution to correct for this dynamic loss of high frequencies. However, there are problems with this approach. The filters must be derived from smaller windows less likely meeting statistical assumptions, and these windowed zones often exhibit phase distortions at the point of overlap.

The other method is to use time variant spectral whitening (TVSW). The method involves passing the input data through a number of narrow band pass filters and determining the decay rates for each frequency band. Inverse of these decay functions, for each frequency band, are applied and the results summed. This way the amplitude spectrum for the output data is whitened in a time variant way. The number of filter bands, the width of each band and the overall bandwidth of application are the different parameters that are used adjustment for an optimized application. This method usually has the high frequency noise getting amplified and so a bandpass filter needs to be run on the resulting data. Being a trace-by-trace process, TVSW is not appropriate for amplitude variation with offset (AVO) applications.

If an analytic form of the earth's attenuation function were known it would be straightforward to compensate for attenuation effects. Since the earth's attenuation function is unknown, attempts are made to estimate a Q model for the subsurface. Inverse Q filtering is resorted to, which removes the time variant wavelet effects by absorption and broadens the effective seismic bandwidth by correcting the loss of high frequency signal. These attempts have met with a varying degree of success depending on the assumptions used in the particular approach and how well they are met in practice.

The different techniques for estimating Q from seismic and acoustic data are spectral ratios, rise time methods, forward modeling and inversion. The simplest method for Q estimation from seismic data adopts a straightforward approach. It is based on a constant Q approximation within intervals and one-dimensional propagation, i.e. it assumes no horizontal velocity and Q variations. Common Depth Point (CDP) gathers are used to generate inverse Q filtered panels for different Q values, just like conventional constant analysis panels. Amplitude spectra are computed for time moving windows and compared to source wavelet spectra to yield time variant Q functions. However, the method is not robust enough to be universally applicable for all data types.

Normal Move Out (NMO) corrected Common Midpoint (CMP) gathers may be used to compute spectra of each trace and stack several corrected spectra over an offset range, which yields the spectral ratio between the source and reflector. The slope of the variation of natural log (spectral ratio) versus frequency is then computed. The slope of spectral ratios are expected to have a linear relationship against the square of offset. Intercept of this line is used to estimate average Q value to the reflector. The computed averages of Q to different reflectors are then used to determine Q for the intervals.

The estimation of the slope of the log spectral ratio versus frequency relationship has a direct bearing on the computed Q values. Accurate estimates of slope and intercept are very important. However, departures from linearity are usually noticed on spectral ratio plots. The standard techniques like least squares data fitting technique do not always give reliable slopes and intercepts. Other problems encountered when using spectral ratios are the suppression of ringing effects in the spectral ratios and the elimination of contamination from interfering wave modes. It has been difficult to measure Q from surface seismic data.

Spectral ratios in VSP data may be computed between each direct arrival waveform and the direct arrival at some reference depth and interval Q's are estimated by measuring the slope of linear segments on the resulting cumulative attenuation versus depth plots. The spectral ratio method as applied to VSPs makes the following assumptions: (i) the source waveform is uniform from level to level, (ii) ground coupling is the same from level to level, (iii) there is no interference from reflected waves (suspect assumption) (iv) there is no variation in stratigraphic filtering between different levels (v) Q is independent of frequency in the VSP data bandwidth range which implies equation (1) is a linear equation with a constant attenuation, and (vi) noise is negligible which means method is applicable to reasonably good data.

The amplitude spectrum A(z, f ) of the trace from a level Z is assumed to decay exponentially from a reference amplitude A(z₀, f) at level z₀.

A(z,f)=A₀(z₀, f)exp[−α(z−z₀)] (4)

$$ln \frac{A ( z , f )}{{A}_{0} ( {z}_{0} , f )} = - α ( z - {z}_{0} ) \\ \frac{ln \frac{A ( z , f )}{A0 ( z0 , f )}}{f} = - \frac{π ( T - {T}_{0} )}{Q} \\ Q = - \frac{π ( T - {T}_{0} )}{Slope} where Slope = \frac{ln \frac{A ( z , f )}{A0 ( z0 , f )}}{f} \qquad ( 5 )$$

This gives

where T and T₀ are the first arrival times at levels z and z₀ respectively.

Anelastic absorption is difficult to estimate from VSP data. Often, a significant number of VSP depth levels are not useful for computation of Q by the spectral ratio method. Estimates of Q values computed from downgoing wavefields using the spectral ratio method are often found to be negative. Whatever the reasons, negative values are definitely a shortcoming of the spectral ratio method. However, the method of the present invention utilizes the full range of the depth levels and so has a wider interval available for filter computation. As is well known by practitioners in the art, seismic data may be represented in time or in depth, and methods for converting time measurements to depth measurements and vice versa are well known. ‘Depth levels’ as used when describing this invention, refer to data levels which are data sample positions in the data set, and may be represented equally well in time at time samples or in depth at depth sample positions.

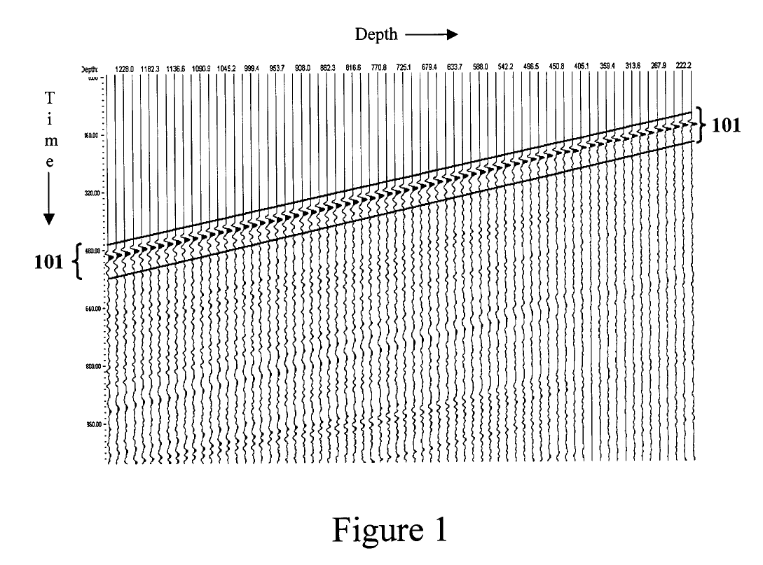

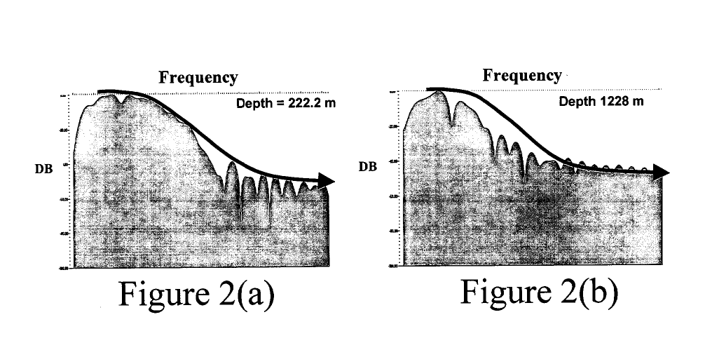

The method of the present invention is for determination of attenuation from VSP data and has application to surface seismic data. This method utilizes the amplitude/frequency decay experienced at different VSP depth levels in a well. FIG. 1 shows the separated downgoing VSP wavefield. Examination of the wavelets in the highlighted zone 101 indicate the decrease in the frequency levels from the shallow (right) to the deeper levels (left). The amplitude spectra in FIG. 2(a) and FIG. 2(b) shows the decrease in amplitude of the different frequency components between a shallow depth level (222.2 m, FIG. 2(a)) and a deeper depth level (1228 m, FIG. (2(b)). For the VSP downgoing signals displayed in FIG. 1, the ratio of the change in trace amplitudes at successive depths would describe the decay of frequency components between those observation points. The physical processes responsible for this decay in amplitude are absorption, transmission losses and scattering.

The change in the trace amplitudes and the length of the wavelet on the first arrivals at successive depth levels is used to estimate the change in the frequency components. An inverse operator (in time domain) is then designed to compensate for the changes. For successive depth levels, a suite of such operators is generated.

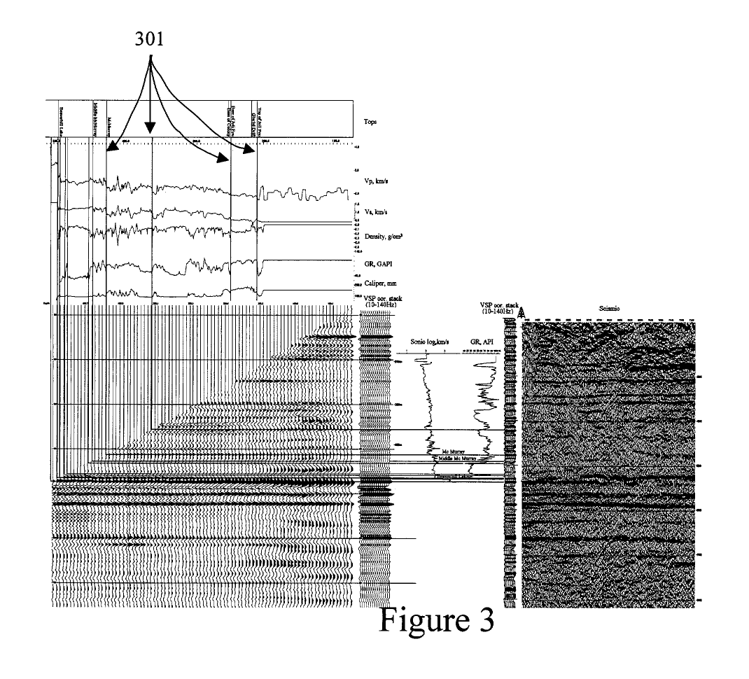

For application to seismic data, first the aligned VSP upgoing wavefield is correlated with the seismic section so that each depth level position is seen in terms of a two-way travel time where the predetermined operators need to be applied. FIG. 3 shows such a correlation. The left hand side of FIG. 3 shows the subsurface stratigraphy and the different logs tied (in depth) to the upgoing VSP wavefield. A good correlation here is essential for the accuracy of the correction. On the right hand side, we see the VSP corridor stack (in time) shown correlated with logs, a filtered version of the corridor stack and the seismic section. The green lines 301 indicate the depth-to-time matching of individual formation tops seen on the logs and upgoing wavefield (in depth) with the surface seismic data. This fixes the VSP upgoing wavefield extent or spread on the seismic data. The first operator corresponding to the first depth level is now assigned a starting time, and so in this way, each determined operator has a corresponding time or depth node point application on the surface seismic data section. Each VSP depth level node has a corresponding surface seismic data node. In between these time (or depth) node points, the operators are interpolated so that each time or depth sample on the seismic trace has an operator. Interpolation may be accomplished by any known method, for example, linear interpolation, bilinear interpolation, spline interpolation, Lagrange interpolation, or others known in the art.

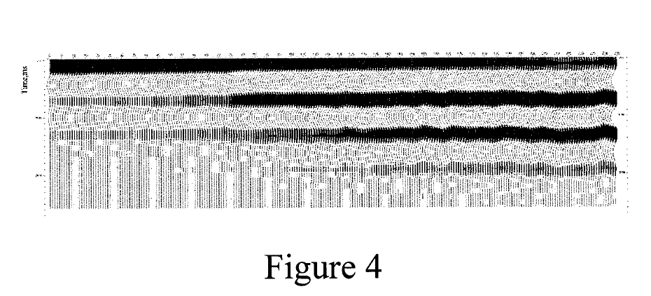

FIG. 4 shows a set of interpolated operators. Thereafter, the filter application is run (as convolution in time domain) on the seismic data. Because operators are applied continuously at every sample of the stacked data, windowing is avoided. Application of these inverse operators on surface seismic data enhance the frequency bandwidth of the surface seismic data by restoring the attenuated frequency components.

Applications of this high frequency restoration (HFR) procedure have been evaluated for various subsurface configurations in the context of hydrocarbon exploration. The following examples illustrate the advantages of adopting the method of the present invention, the HFR procedure.

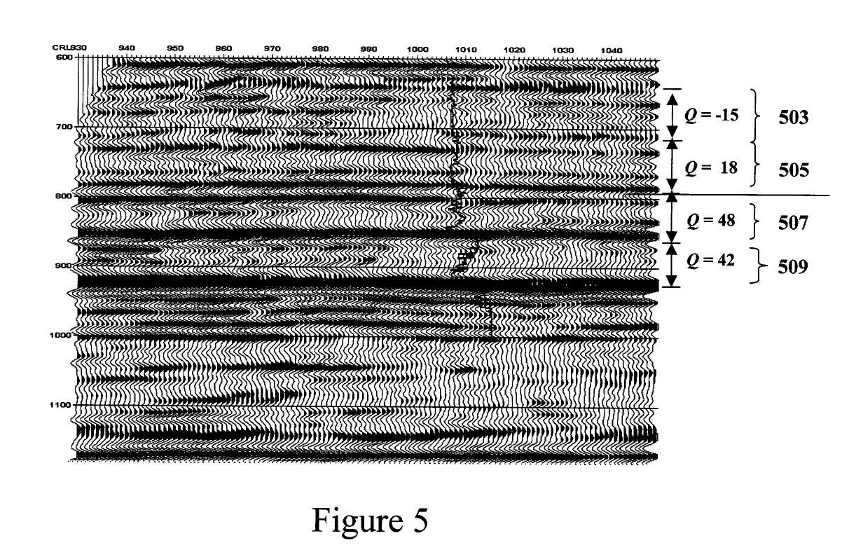

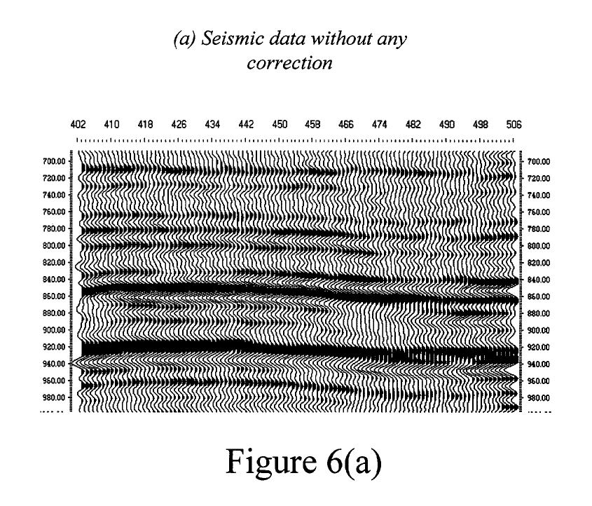

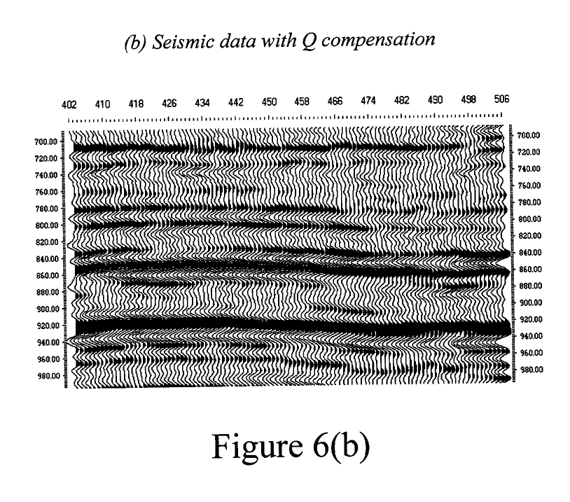

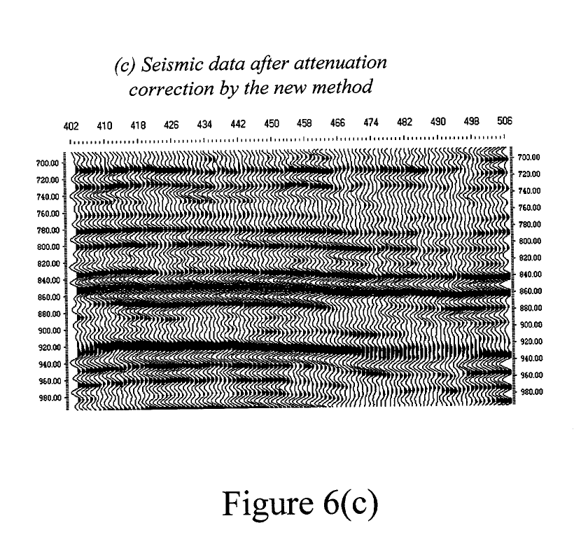

FIG. 5 shows a segment of a seismic section where Q values have been determined using the spectral ratio method from VSP downgoing wavefields as indicated by the arrows to the right on the seismic section. Q values were computed from the VSP downgoing wavefield for the four broad formation zones. The shallowest zone 503 has a negative Q value which is meaningless. The other values 505, 507 and 509 were used for inverse Q filtering to achieve stationarity of the embedded wavelet and in the process enhances the frequency content. An example of an application of the spectral ratio method may be seen by comparing FIG. 6(a), the data before inverse filtering, to the resulting section that is shown in FIG. 6(b) after the application of the method.

The same data set of FIG. 6(a) was then put through the HFR procedure explained above. The output section is shown in FIG. 6(c). Clearly, the full depth range for the VSP (as indicated by the sonic log) was used in this application. There is improvement brought about by Q application using the method of the present invention. Notice the enhanced resolution and continuity of individual reflections as seen in FIG. 6(c). Such sections are easier to interpret accurately.

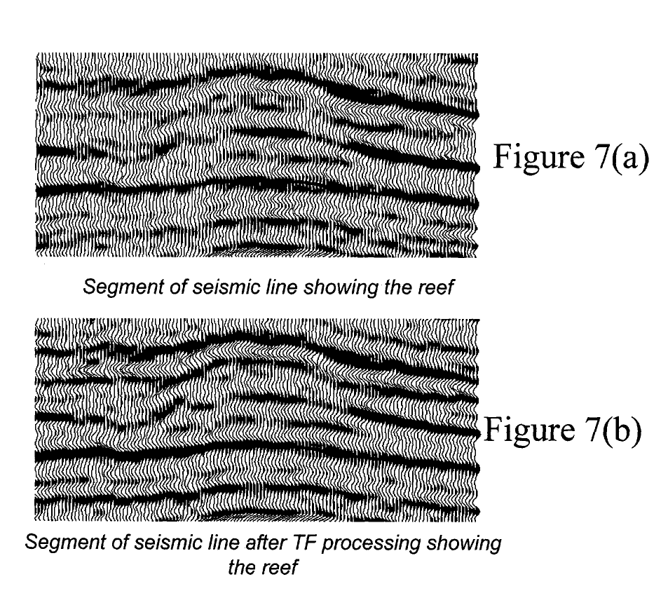

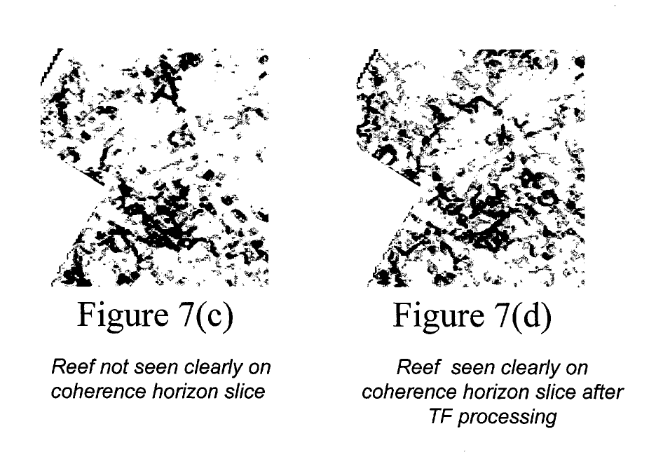

The high frequency restoration of surface seismic data has also been evaluated by running the Coherence Cube analyses (edge detection processing to emphasize discontinuities) on the seismic volumes before and after application of the method of the present invention. FIG. 7 shows the seismic expression of a reef before FIG. 7(a) and after FIG. 7(b) filtering. The boundary of the reef is not seen clearly on the horizontal slice FIG. 7(c) from the Coherence Cube analysis before HFR application, but seen quite crisp-and-clear on the Coherence Cube horizon slice FIG. 7(d) that was run after HFR.

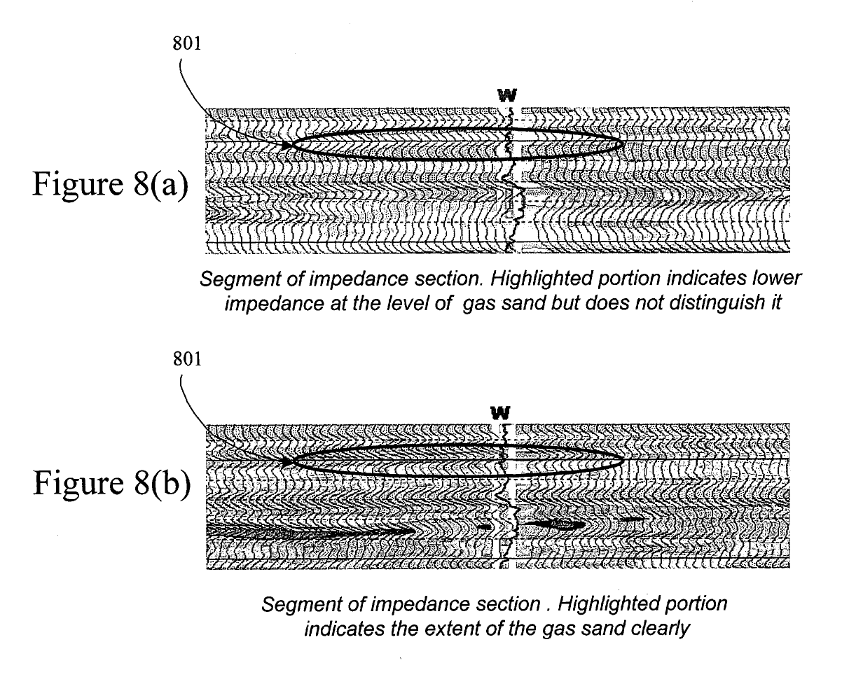

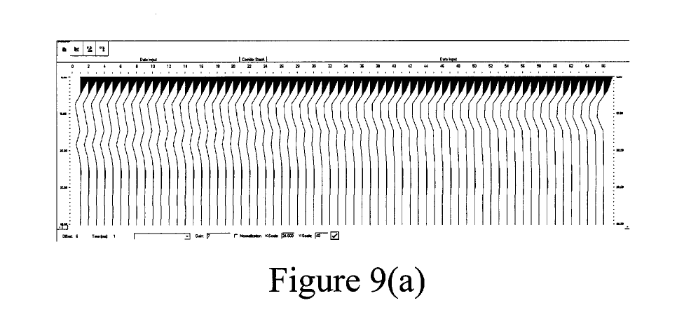

As demonstrated in Hirsche, W. K., Cornish, B. E., Wason, C. B. and King, G. A., 1984, Model-based Q compensation, 54th Ann. Internat. Mtg: Soc. of Expl. Geophys., Session:S18.7, Q values may be estimated using time differences between sonic and seismic data. Hirsche et al. show that features that could not be detected on seismic inversion before Q deconvolution are clearly visible after and conclude that Q correlation prior to seismic inversion allows detailed interpretation of important stratigraphic features. FIG. 8(a) shows segments of an impedance section. A gas producing well W is seen intersecting the circled highlighted portion corresponding to a gas sand 801. However, the green streak continues across the segment and does not distinguish the gas sand 801. The HFR procedure was run on the seismic section and submitted to impedance inversion processing (FIG. 8(b)). Notice the dark green streak (low impedance, within the highlighted portion) seen clearly representing the gas sand 801.

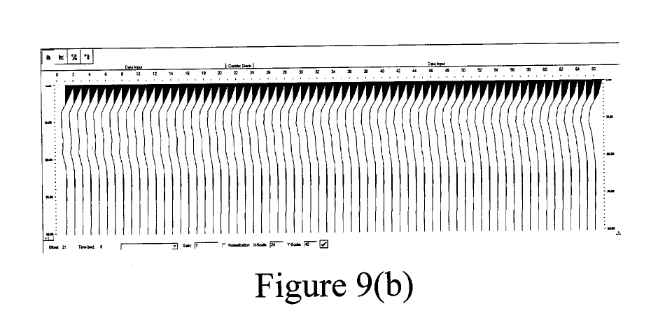

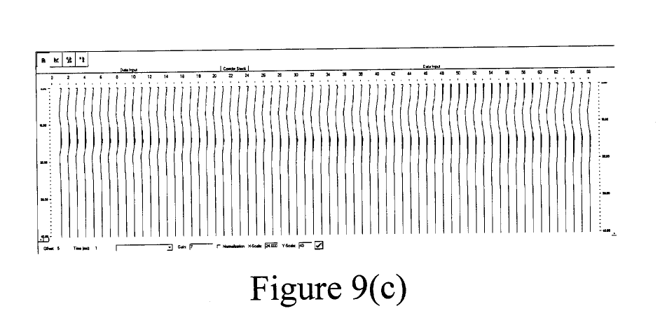

An important element that lends strong support to the utility of any procedure is its robustness. The set of inverse filters were computed from VSPs in different wells in the same field/area as for FIG. 8(a) and FIG. 8(b). The objective was to determine how different these sets of filters were. FIG. 9(a) illustrates the filter determined from Well A, and FIG. 9(b) illustrates the filters determined from Well B. The difference of the two filters from the two different wells is illustrated in FIG. 9(c) to show their difference. Clearly, the filters are almost identical. For the same area, if the geology does not change abruptly, the filter sets should be the same or very similar, of course assuming the data quality is good and is acquired using similar equipment. For areas where geology changes fast laterally, a space adaptive filter application approach may be used in combination with this method.

In summary, the method of the present invention is used to determine the decay in amplitude from the downgoing first arrivals from successive depth levels and then apply an inverse decay function to subsurface seismic data. This allows us to take advantage of higher resolution and signal-to-noise ratio of VSP data and enhance the bandwidth of seismic data. This procedure is robust and helps define trends better, leading to more confident interpretations.

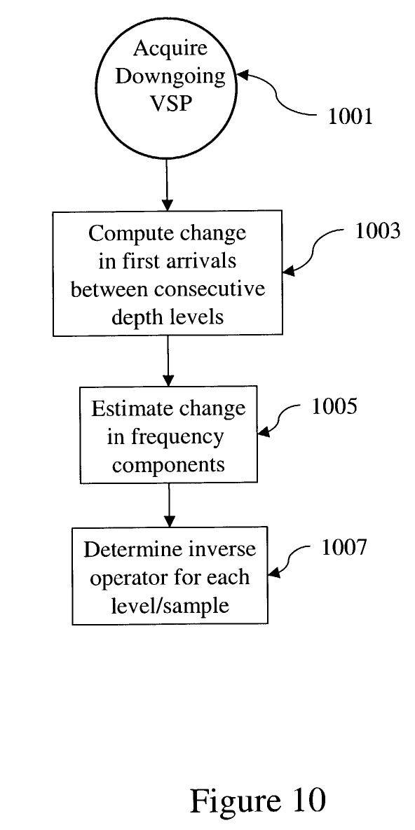

A flow chart showing the method of deriving the operator to apply to surface seismic data is shown in FIG. 10. Downgoing seismic data 1001, which in a preferred embodiment is VSP seismic data, is acquired at several depth or time levels over the subsurface zones of interest. The wavelet changes in the trace characteristics, for example amplitudes and length of the wavelets of the first arrivals, of the downgoing seismic data are computed 1003. The change in frequency is estimated 1005 from the changes between consecutive time/depth levels. An inverse operator is then determined 1007 for each level. For application to time or depth data, the determined inverse operators are interpolated so that an operator may be applied for every data sample position.

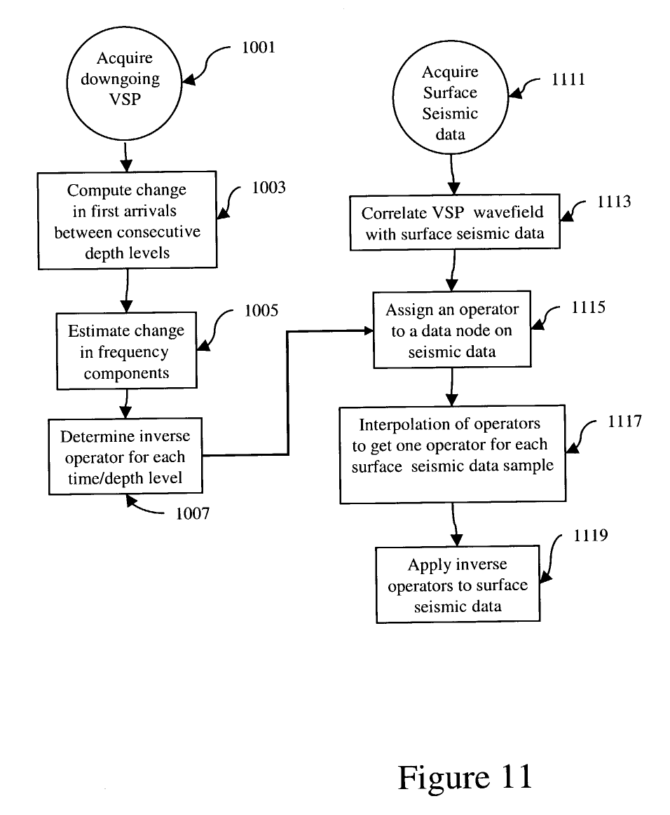

A flow chart demonstrating the application of the method to surface seismic data is shown in FIG. 11. Surface seismic data is acquired 1111 over an area of interest. Using VSP information and any other information available for the area of interest the subsurface wavefield information is aligned 1113 as explained with reference to FIG. 3 so that corresponding levels of the downgoing seismic wave field are aligned with equivalent levels or steps (for clarity referred to as nodes) on the surface seismic data. During processing and application of the method of the present invention, a time or depth level has an equivalent time or depth surface seismic node for correspondence. The inverse operators that have been determined from the downgoing seismic data levels (FIG. 10) determined from VSP data are assigned 1115 to corresponding time (or depth) nodes on the surface seismic data. For data samples between assigned nodes, inverse operators are interpolated 1117 so that a unique inverse operator may be present for each time or depth sample step. The inverse operators may then be applied 1119 to the surface seismic data by convolution in the time domain. The surface seismic data will have high frequencies restored.

Persons skilled in the art will understand that the methods described herein may be practiced as set out in the specification, figures and claims, including but not limited to the embodiments disclosed. Further, it should be understood that the invention is not to be unduly limited to the foregoing which has been set forth for illustrative purposes. Various modifications and alternatives will be apparent to those skilled in the art without departing from the true scope of the invention, as defined in the following claims.

What is claimed is:

1. A method for determining a filter for seismic data comprising:
(a) acquiring downgoing seismic data at a plurality of data levels;
(b) computing a change in a first arrival signal characteristic of said downgoing seismic data relative to at least one said data level; and,
(c) determining an inverse operator filter for the at least one said data level using said computed change in a first arrival signal characteristic.

2. The method of claim 1 wherein said computed changes in the first arrival signal characteristics are computed relative to adjacent data levels.

3. The method of claim 1 wherein said computed changes in said first arrival signal characteristics are computed using at least one characteristic chosen from the group comprising: i) first arrival amplitude, ii) first arrival wavelet length, and iii) first arrival wavelet frequency.

4. The method of claim 1 further comprising applying said inverse operator filter to surface seismic data.

5. The method of claim 1 further comprising determining at least one inverse operator filter using interpolation.

6. The method of claim 5 wherein interpolation is chosen from at least one of: i) linear interpolation, ii) bilinear interpolation, iii) spline interpolation, and iv) Lagrange interpolation.

7. The method of claim 1 further comprising determining the inverse filter operator to restore attenuated frequencies to seismic data.

8. A method of processing seismic data over a subsurface area of interest comprising:
(a) acquiring downgoing VSP data and surface seismic data over a subsurface area of interest;
(b) determining an inverse operator from changes in signal characteristics between consecutive depth levels of the downgoing VSP data; and
(c) assigning said inverse operator to at least one surface seismic data node.

9. The method of claim 8 further comprising applying said inverse operator to said surface seismic data.

10. The method of claim 8 further comprising determining a surface seismic inverse operator for surface seismic data between said surface seismic data nodes by interpolation.

11. The method of claim 10 wherein interpolation is chosen from at least one of: i) linear interpolation, ii) bilinear interpolation, iii) spline interpolation, and iv) Lagrange interpolation.

12. The method of claim 10 further comprising applying said surface seismic inverse operator to surface seismic data.

13. The method of claim 8 further comprising determining the inverse filter operator to restore attenuated frequencies to seismic data.

14. A method of filtering seismic data over a subsurface area of interest comprising:
(a) acquiring downgoing VSP data and surface seismic data over a subsurface area of interest;
(b) determining an inverse operator from changes in signal characteristics between consecutive depth levels of the downgoing VSP data;
(c) aligning downgoing VSP data levels with corresponding surface seismic data nodes; and
(d) assigning said inverse operator to at least one said corresponding surface seismic data node.

15. The method of claim 14 further comprising determining a surface seismic inverse operator for at least one surface seismic data sample between said surface seismic data nodes by interpolation.

16. The method of claim 15 wherein interpolation is chosen from at least one of: i) linear interpolation, ii) bilinear interpolation, iii) spline interpolation, and iv) Lagrange interpolation.

17. The method of claim 15 further comprising applying the surface seismic inverse operator to said surface seismic data.

18. The method of claim 14 further comprising applying the inverse operator to said surface seismic data.

19. The method of claim 14 further wherein determining said inverse operator further comprises estimating changes in the signal characteristics of the group comprising: i) signal length, ii) signal amplitude and iii) signal frequency.

20. The method of claim 14 further comprising determining the inverse filter operator to restore attenuated frequencies to seismic data.
